(19) United States
(12) Patent Application Publication
(10) Pub. No.: US 2018/0017807 A1
(43) Pub. Date: Jan. 18, 2018

(54) Eyeglass Assemblies

(71) Applicant: Beta Group LLC, Menlo Park, CA (US)

(72) Inventor: Robert B. Zider, Portola Valley, CA (US)

(73) Assignee: Beta Group LLC, Menlo Park, CA (US)

(21) Appl. No.: 15/548,084

(22) PCT Filed: Feb. 2, 2016
(86) PCT No.: PCT/US16/16228

§ 371 Date: Aug. 1, 2017

Related U.S. Application Data
(60) Provisional application No. 62/111,503, filed on Feb. 3, 2015.

(51) Int. Cl. G02C 1/02

(52) U.S. Cl. CPC G02C 1/02

(57) ABSTRACT

Eyeglass assemblies comprise (1) a shear pin which secures a frame member (1, 12) to a lens (11) or two frame members to each other, and/or (2) components which are substantially more transparent to ultraviolet radiation than the lens material, and/or (3) auxiliary members (14) which extend upwards from the lenses and facilitate correct positioning of the eyeglass assembly.

### CROSS-REFERENCE TO RELATED APPLICATIONS

This application claims priority from and the benefit of co-pending US provisional application 62/111,503, filed 3 Feb., 2015.

### FIELD OF THE INVENTION

This invention relates to eyeglass assemblies.

### BACKGROUND

In eyeglasses which have been relatively recently developed by Avantek, (i) each lens has a pair of engaging portions which extend from the periphery of the lens, (ii) a bridge member is attached to first engaging portions on each of the lenses, (iii) two frame members respectively attached to second engaging portions of each lens, and (iv) two temple members respectively attached at a hinged connection to a frame member. In other eyeglasses recently developed by Avantek, the frame member is a continuous bar (a “brow bar”) which extends between the temple members, each lens has a single engaging portion which extends from the upper periphery of the lens and is attached to the brow bar, and each end of the brow bar is attached at a hinged connection to a temple member. For further information about these and similar eyeglasses, reference may be made to U.S. Pat. Nos. 6,164,775, 8,322,849, 8,465,150, 8,622,541 and 8,985,762. The entire disclosure of each of those patents is incorporated herein by reference for all purposes.

### BRIEF SUMMARY OF THE INVENTIONS

This specification discloses a number of different inventions in the field of eyeglass assemblies. The inventions can be used independently or in combination. The first invention relates to the use of a shear pin to reinforce the connection between a frame member and an engaging portion on the lens or between two frame members. The second invention relates to securing together a frame member and a lens engaging portion, or two frame members, by means of an adhesive which is cured by exposure to electromagnetic radiation of a particular frequency, e.g. ultraviolet radiation; the invention makes use of a lens engaging portion and/or a frame member which is relatively transparent to electromagnetic radiation of that frequency. The third invention relates to an eyeglass assembly in which auxiliary members extend upwards above each of the lenses of an eyeglass assembly and which can be used to ensure the correct positioning of the eyeglass assembly on the wearer.

### THE FIRST INVENTION

It has been found that the security of the connection between two frame members or between a frame member and an engaging portion on a lens, produced for example by following the procedures disclosed in the patents set out above and incorporated by reference, can be compromised if one of the connecting surfaces is contaminated, e.g. by paint or an oil, at the time the connection is made, or if oil from the skin of the wearer of the eyeglasses contacts the connecting surfaces.

In the first invention, at least one shear pin, for example a metallic or polymeric pin, is placed through contacting parts of an eyeglass frame member and an engaging portion on a lens or through contacting parts of first and second eyeglass frame members. The invention is particularly useful for strengthening the connection between an engaging portion on a lens and a frame member in contact with the engaging portion. A hole is provided through the frame member and at least part way through the engaging portion. The hole through the frame member can be made before the frame member is mated with the engaging portion, or the hole can be made, after the frame member has been mated with the engaging portion, through the frame member and into, and optionally through, the engaging portion. The presence of the shear pin reduces the danger that the connection will be compromised.

It is sometimes desirable to disassemble an eyeglass assembly containing such a shear pin. To facilitate disassembly, the exposed surface of the shear pin can be provided with means facilitating the subsequent removal of the shear pin, for example a non-circular recess or a threaded hole, into which a screw or an instrument can be placed to enable the shear pin to be removed.

It has been found that, if a single shear pin having a circular cross-section is used, and the bonding between an engaging portion on a lens and a frame member, or between two frame members, is substantially reduced, the resulting connection, though maintained by the shear pin, can be unstable as a result of rotation around the shear pin. The resulting loose connection enables the lens to rotate from the desired location in front of the eyes.

In one embodiment, therefore, the pin has a non-circular cross-section, e.g. a cross-section which is oval or polygonal, including triangular and rectangular (including square), optionally with rounded corners. The holes in the frame member and the engaging member can have the same cross-section as the non-circular pin or one or both can have a different cross-section such that the shear pin cannot rotate. In some cases, it may be advantageous to use a hole having a different cross-section to provide a relief path for excessive adhesive to escape.

In another embodiment, two shear pins are used. The pins are optionally secured together by a bridge. The bridge can optionally fit partially or completely into a depression in the outside surface of the frame member. Using a bridge, both pins can be inserted simultaneously, and, if need be, can be removed simultaneously. The exposed surface of the bridge can be provided with means facilitating the subsequent removal of the bridge, and the shear pins attached to it, for example a non-circular recess or a threaded hole, into which a screw or an instrument can be placed to enable the shear pin to be removed.

When the shear pin is used in conjunction with an adhesive which is activated by electromagnetic radiation of a particular frequency or range of frequencies, in particular ultraviolet radiation, the shear pin is preferably composed of a material which is transparent to that electromagnetic radiation, thus assisting the curing of the adhesive.

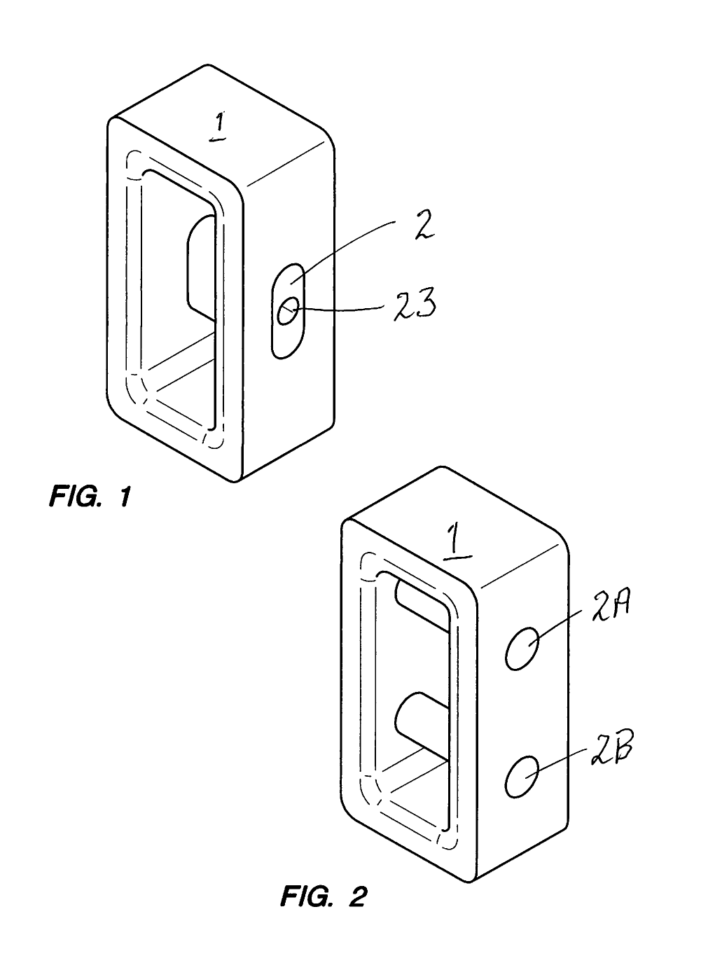

The first invention is illustrated in FIGS. 1-3, which are diagrammatic and not to scale.

FIG. 1 illustrates the end section (1) of a frame member containing a rectangular orifice which fits around an engaging portion on a lens, with a non-circular shear pin (2) in place. In the interest of clarity, the Figure does not show the engaging portion of the lens into which the shear pin is inserted. The exposed end of the shear pin (2) has a threaded hole (23) into which a screw can be inserted to assist in removal of the shear pin.

FIG. 2 illustrates the end section (1) of a frame member containing a rectangular orifice which fits around an engaging portion on a lens, with two shear pins (21, 22) in place. In the interest of clarity, the Figure does not show the engaging portion of the lens into which the shear pins are inserted.

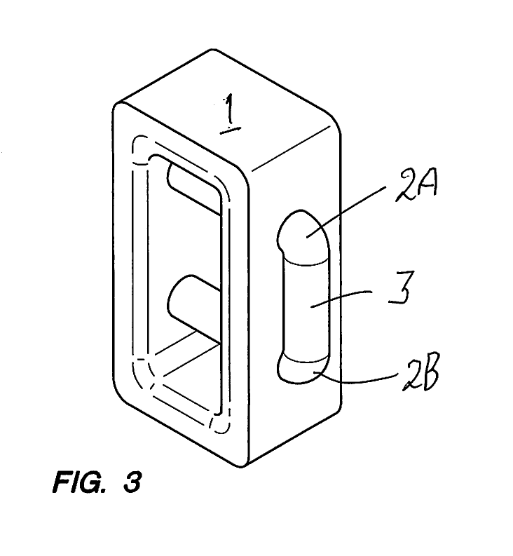

FIG. 3 illustrates the end section (1) of a frame member containing a rectangular orifice which fits around an engaging portion on a lens, with two shear pins (21, 22) which are joined together by a bridge (3). In the interest of clarity, the Figure does not show engaging portion of the lens into which the shear pins are inserted.

### SECOND INVENTION

The second invention relates to securing together a frame member and a lens engaging portion, or two frame members, by means of an adhesive which is cured by exposure to electromagnetic radiation of a particular frequency, e.g. ultraviolet radiation. The invention makes use of a lens engaging portion and/or a frame member which is relatively transparent to electromagnetic radiation of that frequency, thus enhancing the curing of the adhesive. The invention is particularly useful when an adhesive is used to secure the engaging portion of a lens to an eyeglass frame member, as described in the patents and applications set out above and incorporated by reference herein.

Eyeglass lenses are normally made of a polycarbonate which is not transparent to ultraviolet light. Therefore, in methods in which the lens has an engaging portion which is integral with the remainder of the lens, the engaging portion is a barrier to the ultraviolet light which is often used to activate the adhesive which bonds the engaging portion to the frame member. The second invention includes an eyeglass lens which has a body portion which is composed of a polycarbonate material or other material which is not transparent to ultraviolet light, and an engaging portion which is bonded to the periphery of the lens and which is composed of a material which is substantially more transparent than polycarbonate to ultraviolet radiation. The engaging portion can, for example, be composed of a polymeric material which has a transparency to ultraviolet light which is more than 2 times, preferably more than 4 times, the transparency of the body portion of the lens.

The engaging portion can be secured to the periphery of the polycarbonate lens in any way. The periphery of the lens can be shaped to enhance the bonding of the engaging portion to the periphery, for example a shallow channel into which the engaging portion fits.

### THE THIRD INVENTION

The third invention is an eyeglass assembly in which auxiliary members extend upwards above each of the lenses of a pair of eyeglasses. The invention is applicable to all eyeglass assemblies, no matter how constructed and no matter how the lenses are secured to the eyeglass frame. In one embodiment, the auxiliary members are the engaging portions which secure the lenses to the brow bar of an eyeglass assembly as described in U.S. Pat. No. 8,622,541. The auxiliary members are positioned so that they are not in the user's field of vision when the eyeglass assembly is correctly positioned, but are in the user's field of vision when the eyeglass assembly is not correctly positioned. This is especially useful when the lens is a complex lens having different optical properties at different levels, for example a bifocal, trifocal or progressive lens.

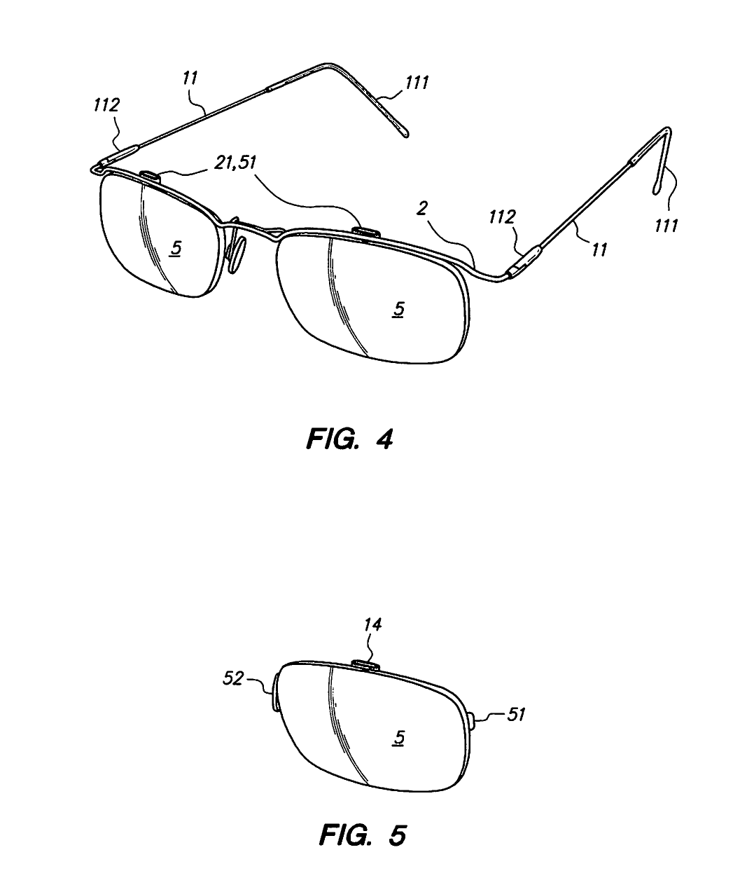

The third invention is illustrated in FIGS. 4 and 5, which are diagrammatic and not to scale. In FIG. 4, there are lenses 5, 5 which are attached to a frame member 2 which is a brow bar. The frame member 2 is attached, through hinges 112, 112, to temple members 11, 11. Engaging members 21, 51 secure the, lenses to the brow bar and extend upwards from the center of each lens. FIG. 5 shows a lens 5 having engaging members 51 and 52 at the corners of the lens and auxiliary member 14 extending upwards from the center of the lens.

The third invention includes a method in which an eyeglass assembly is adjusted on the face of the wearer, the eyeglass assembly comprising one or more auxiliary members as defined above. This method is particularly valuable when used in conjunction with temple members which have been shaped to fit around the ears of the wearer in order to assist the correct positioning of the lenses in front of the wearer. Preferably, the temple members of each pair of eyeglasses should be custom fitted to the person who is going to use the eyeglasses. For example, the wearer should have available to him or her a range of temple members from which he or she can select the temple members which place the lenses in the right position, as determined by the auxiliary members. Alternatively, the temple members can be made of a material, for example a nickel titanium alloy, which can be shaped to the wearer's exact requirements and which will maintain its shape unless deliberately changed.

The third invention includes a lens which comprises a body portion 5, two attachment means at the corners of the lens, for example two engaging portions 51 and 52 which extend from the periphery of the lens and which can be secured to frame members, and an auxiliary member 14 which extends upwards from the middle of the lens.

### The Following Statements Define Particular Combinations of Features of the Inventions.

Statement A1. An eyeglass assembly which comprises
   (1) a lens having an engaging portion which extends from the periphery of the lens,
   (2) a frame member which fitted around and contacts the engaging portion, and
   (3) a shear pin which passes through a hole in the frame member and into a hole in the engaging portion.
Statement A2. An eyeglass assembly according to Statement A1 wherein the shear pin has a non-circular cross-section, e.g. a cross-section which is oval or polygonal, including triangular and rectangular (including square), optionally with rounded corners.
Statement A3. An eyeglass assembly according to Statement A2 wherein the holes in the frame member and the engaging member have the same cross-section as the non-circular shear pin or a different cross-section such that the shear pin cannot rotate.
Statement A4. An eyeglass assembly according to any of Statements A1-A3 which includes two shear pins.
Statement A5. An eyeglass assembly according to Statement A4 wherein the pins are secured to a bridge.
Statement A6. An eyeglass assembly according to Statement A5 wherein the bridge fits partially or completely into a depression in the outside surface of the frame member.
Statement A7. An eyeglass assembly according to Statement A5 or Statement A6 wherein the bridge has an exposed surface which provides means facilitating the removal of the bridge and the shear pins attached to it.
Statement A8. An eyeglass assembly according to any one of Statements A1-A7 when the contacting surfaces of the engaging portion and the frame member are secured together by an adhesive which is cured by electromagnetic radiation, and the shear pin is composed of a material which is transparent to that electromagnetic radiation.
Statement A9. An eyeglass assembly according to Statement A8 wherein the lens is composed of a polycarbonate, the adhesive is cured by ultraviolet light, and the shear pin is composed of a polymeric material which has a transparency to ultraviolet light which is more than 2 times, preferably more than 4 times, the transparency of polycarbonate.
Statement A10. An eyeglass assembly according to Statement A9 wherein the body of the lens is composed of a polycarbonate, the adhesive is cured by ultraviolet light, and the engaging portion and the shear pin are composed of a polymeric material which has a transparency to ultraviolet light which is more than 2 times, preferably more than 4 times, the transparency of polycarbonate.
Statement A11. An eyeglass assembly according to any one of Statements A1-A10 which comprises
   (4) auxiliary members which extend upwards above each of the lenses and which are positioned so that they are not in the user's field of vision when the eyeglass assembly is correctly positioned, but are in the user's field of vision when the eyeglass assembly is not correctly positioned.
Statement A12. An eyeglass assembly according to any of Statements A1-A11 wherein the frame member has a generally tubular portion which fits around at least part of the engaging portion.
Statement A13. An eyeglass assembly according to Statement A12 wherein there is an adhesive between the contacting surfaces of the frame member and the engaging portion.
Statement A14. An eyeglass assembly according to Statement A12 or A13 which comprises
   (4) a securing member which is bonded to the engaging portion and to surfaces of the frame member which, in the absence of the securing member are exposed to the atmosphere.
Statement A15. An eyeglass assembly according to Statement A14 wherein
   (i) the generally tubular portion of the frame member (a) has a closed cross-section and open ends, and (b) extends completely around the engaging portion, and
   (ii) the securing member is bonded to outer surfaces of the engaging portion and of the frame member.
Statement A16. An eyeglass assembly according to Statement A14 wherein
   (i) the generally tubular portion of the frame member (a) has an open cross-section, and (b) extends around part of the engaging portion, and
   (ii) the securing member is bonded to outer surfaces of the engaging portion and of the frame member.
Statement A17. An eyeglass assembly according to Statement A15 or Statement A16 wherein the securing member is bonded to the engaging portion and the frame member by an adhesive.
Statement A18. An eyeglass assembly according to Statement A15 or Statement A16 wherein the securing member comprises a polymeric composition which is melt bonded to the engaging portion and to the frame member.
Statement A19. An eyeglass assembly according to Statement A18 wherein the securing member and the engaging portion are monolithic, the securing member having been produced by melting the engaging portion.
Statement B1. An eyeglass assembly which comprises
   (1) a lens which comprises (i) a body portion which has low transparency to ultraviolet radiation, and (ii) an engaging portion which extends from the periphery of the lens, and
   (2) a frame member having a generally tubular portion which fits around at least part of the engaging portion and contacts the engaging portion,
      the engaging portion and the lens being attached to each other by one or more of
   (i) an adhesive which lies between the contacting surfaces of the engaging portion and the frame member, and
   (ii) a securing member which is bonded by an adhesive to the engaging portion and to surfaces of the frame member which, in the absence of the securing member are exposed to the atmosphere;
      the adhesive having been cured by exposure to ultraviolet radiation, wherein one or both of the lens engaging portion and the frame member is composed of a material which is substantially more transparent to ultraviolet radiation than the body portion of the lens.
Statement B2. An eyeglass assembly according to Statement B1 wherein the body portion of the lens is composed of a polycarbonate and the engaging portion of the lens is composed of a polymeric material which has a transparency to ultraviolet light which is more than 2 times, preferably more than 4 times, the transparency of polycarbonate.
Statement B3. An eyeglass assembly according to Statement B1 or Statement B2 wherein the body portion of the lens is composed of a polycarbonate and the frame member is composed of a polymeric material which has a transparency to ultraviolet light which is more than 2 times, preferably more than 4 times, the transparency of polycarbonate.
Statement B4. An eyeglass assembly according to any one of Statements B1-B3 wherein
   (i) the generally tubular portion of the frame member (a) has a closed cross-section and open ends, and (b) extends completely around the engaging portion, and
   (ii) the securing member is bonded to outer surfaces of the engaging portion and of the frame member.
Statement B5. An eyeglass assembly according to Statement B4 wherein
   (i) the generally tubular portion of the frame member (a) has an open cross-section, and (b) extends around part of the engaging portion, and
   (ii) the securing member is bonded to outer surfaces of the engaging portion and of the frame member.
Statement B6. An eyeglass assembly according to Statement B4 or Statement B5 wherein the securing member is bonded to the engaging portion and the frame member by the adhesive.
Statement C1. A lens which comprises (i) a body portion which is not transparent to ultraviolet radiation, and (ii) an engaging portion which extends from the periphery of the lens and which is composed of a material which is substantially more transparent to ultraviolet radiation than the body portion.
Statement C2. A lens according to Statement C1 wherein the body portion is composed of a polycarbonate.
Statement C3. A lens according to Statement C1 or Statement C2 wherein the engaging portion is composed of a polymeric material which has a transparency to ultraviolet light which is more than 2 times, preferably more than 4 times, the transparency of polycarbonate.
Statement D1. An eyeglass assembly which comprises
   (1) first and second lenses,
   (2) one or more frame members to which the lenses are attached,
   (3) first and second temple members, and
   (4) first and second auxiliary members (i) each of which extends upwards above one of the lenses and (ii) which are positioned so that they are not in the user's field of vision when the eyeglass assembly is correctly positioned, but are in the user's field of vision when the eyeglass assembly is not correctly positioned.
Statement D2. An eyeglass assembly according to Statement D1 wherein (i) each of the lenses comprises a body portion and an engaging portion which extends from the periphery of the body portion, and the frame member or frame members have a generally tubular portion which fits around at least part of the engaging portion.
Statement D3. An eyeglass assembly according to Statement A12 wherein there is an adhesive between the contacting surfaces of the frame member and the engaging portion.
Statement D4. An eyeglass assembly according to Statement D2 or D3 which comprises
   (5) a securing member which is bonded to the engaging portion and to surfaces of the frame member which, in the absence of the securing member are exposed to the atmosphere.
Statement D5. An eyeglass assembly according to Statement D4 wherein
   (i) the generally tubular portion of the frame member (a) has a closed cross-section and open ends, and (b) extends completely around the engaging portion, and
   (ii) the securing member is bonded to outer surfaces of the engaging portion and of the frame member.
Statement D6. An eyeglass assembly according to Statement D4 wherein
   (i) the generally tubular portion of the frame member (a) has an open cross-section, and (b) extends around part of the engaging portion, and
   (ii) the securing member is bonded to outer surfaces of the engaging portion and of the frame member.
Statement D7. An eyeglass assembly according to Statement D5 or Statement D6 wherein the securing member is bonded to the engaging portion and the frame member by an adhesive.
Statement D8. An eyeglass assembly according to Statement D5 or Statement D6 wherein the securing member comprises a polymeric composition which is melt bonded to the engaging portion and to the frame member.
Statement D9. An eyeglass assembly according to Statement D8 wherein the securing member and the engaging portion are monolithic, the securing member having been produced by melting the engaging portion comprises a polymeric composition which is melt bonded to the engaging portion and to the frame member.
Statement D10. An eyeglass assembly according to any one of Statements D1-D9 wherein each of the temple members is composed of a nickel titanium alloy, can be shaped to the wearer's requirements and maintains its shape unless deliberately changed.
Statement D11. An eyeglass assembly according to any one of Statements D1-D10 wherein at least one of the lenses is bifocal.
Statement D12. An eyeglass assembly according to any one of Statements D1-D10 wherein at least one of the lenses is trifocal.
Statement D13. An eyeglass assembly according to any one of Statements D1-D10 wherein at least one of the lenses is a progressive lens.
Statement E1. A method of fitting an eyeglass assembly to a wearer, the method comprising adjusting the temple members of an eyeglass assembly as defined in any one of Statements D1-D13 so that, when the eyeglass assembly is correctly fitted, the wearer does not see the auxiliary members.
Statement F1. A lens which comprises (i) a body portion, (ii) two attachment means at the corners of the lens, for example two engaging portions 51 and 52 which extend from the periphery of the lens and which can be secured to frame members, and (iii) an auxiliary member which extends upwards from the middle of the lens. which comprises a body portion, two engaging portions which extend from the corners of the lens and an auxiliary member 14 which extends upwards from the middle of the lens.

1. An eyeglass assembly which comprises
(1) a lens having an engaging portion which extends from the periphery of the lens,
(2) a frame member which fitted around and contacts the engaging portion, and
(3) a shear pin which passes through a hole in the frame member and into a hole in the engaging portion.

2. An eyeglass assembly according to claim 1 wherein the shear pin has a non-circular cross-section.

3. An eyeglass assembly according to claim 1 wherein the holes in the frame member and the engaging member have a cross-section which is different from the cross-section of the shear pin.

4. An eyeglass assembly according to claim 1 which includes two shear pins.

5. An eyeglass assembly according to claim 4 wherein the two pins are secured to a bridge.

6. An eyeglass assembly according to claim 5 wherein the bridge fits partially or completely into a depression in an exterior surface of the frame member.

7. An eyeglass assembly according to claim 5 wherein the bridge has an exposed surface which provides means facilitating the removal of the bridge and the shear pins attached to it.

8. An eyeglass assembly according to claim 1 wherein the contacting surfaces of the engaging portion and the frame member are secured together by an adhesive which has been cured by exposure to ultraviolet radiation, and the shear pin is composed of a material which is relatively transparent to ultraviolet radiation.

9. An eyeglass assembly according to claim 8 wherein (a) the lens is composed of a polycarbonate, and (b) the shear pin is composed of a polymeric material which has a transparency to ultraviolet light which is more than 2 times, preferably more than 4 times, the transparency of polycarbonate.

10. An eyeglass assembly according to claim 1 which comprises
(4) auxiliary members which extend upwards above each of the lenses and which are positioned so that they are not in the user's field of vision when the eyeglass assembly is correctly positioned, and are in the user's field of vision when the eyeglass assembly is not correctly positioned.

11. An eyeglass assembly which comprises
(1) a lens which comprises (i) a body portion which is not transparent to ultraviolet radiation, and (ii) an engaging portion which extends from the periphery of the lens, and
(2) a frame member having a generally tubular portion which fits around at least part of the engaging portion and contacts the engaging portion,
the engaging portion and the lens being attached to each other by one or more of
(i) an adhesive which lies between the contacting surfaces of the engaging portion and the frame member, and
(ii) a securing member which is secured by an adhesive to the engaging portion and to surfaces of the frame member which, in the absence of the securing member are exposed to the atmosphere;
the adhesive having been cured by exposure to ultraviolet radiation, wherein one or both of the engaging portion and the frame member is composed of a material which is relatively transparent to ultraviolet radiation.

12. An eyeglass assembly according to claim 11 wherein the body portion of the lens is composed of a polycarbonate and the engaging portion of the lens is composed of a polymeric material which has a transparency to ultraviolet light which is more than 2 times, preferably more than 4 times, the transparency of polycarbonate.

13. An eyeglass assembly according to claim 11 wherein the body portion of the lens is composed of a polycarbonate and the frame member is composed of a polymeric material which has a transparency to ultraviolet light which is more than 2 times the transparency of polycarbonate.

14. A lens which comprises (i) a body portion which is not transparent to ultraviolet radiation, and (ii) an engaging portion which extends from the periphery of the lens and which is composed of a material which is substantially more transparent to ultraviolet radiation than the body portion.

15. A lens according to claim 14 wherein the body portion is composed of a polycarbonate and the engaging portion is composed of a polymeric material which has a transparency to ultraviolet light which is more than 2 times the transparency of polycarbonate.

16. An eyeglass assembly which comprises
(1) first and second lenses,
(2) one or more frame members to which the lenses are attached,
(3) first and second temple members, and
(4) first and second auxiliary members which (i) extend upwards above each of the lenses and (ii) are positioned so that they are not in the user's field of vision when the eyeglass assembly is correctly positioned, but are in the user's field of vision when the eyeglass assembly is not correctly positioned.

17. An eyeglass assembly according to claim 16 wherein (i) each of the lenses comprises a body portion and an engaging portion which extends is from the periphery of the body portion, and the frame member or frame members have a generally tubular portion which fits around at least part of the engaging portion.

18. An eyeglass assembly according to claim 16 wherein each of the temple members is composed of a nickel titanium alloy, can be shaped to the wearer's requirements, and maintains its shape unless deliberately changed.

19. An eyeglass assembly according to claim 16 wherein at least one of the lenses is bifocal, trifocal or progressive.

20. A method of fitting an eyeglass assembly to a wearer, the method comprising adjusting the temple members of an eyeglass assembly as defined in claim 16 so that when the eyeglass assembly is correctly fitted, the wearer does not see the auxiliary members.

21-22. canceled
